(19) United States
(12) Patent Application Publication
(10) Pub. No.: US 2026/0167514 A1
(43) Pub. Date: Jun. 18, 2026

(54) MONODISPERSED SPHERICAL RARE EARTH OXIDES

(71) Applicant: Neo Performance Materials (Singapore) Pte. Ltd., Singapore (SG)

(72) Inventors: Szu Hwee NG, Singapore (SG); Yong YAN, Singapore (SG); Shijia LIU, Singapore (SG); Jia Onn LIEW, Singapore (SG); Benedict HSU, Singapore (SG)

(73) Assignee: Neo Performance Materials (Singapore) Pte. Ltd., Singapore (SG)

(21) Appl. No.: 19/124,788

(22) PCT Filed: Mar. 25, 2024
(86) PCT No.: PCT/IB2024/000166

§ 371 Date: Apr. 25, 2025

Related U.S. Application Data
(60) Provisional application No. 63/491,805, filed on Mar. 23, 2023.

(51) Int. Cl. C01F 17/229; C01F 17/218; C01F 17/224

(52) U.S. Cl. CPC C01F 17/229; C01F 17/218; C01F 17/224; C01P 2002/72; C01P 2002/76; C01P 2004/03; C01P 2004/32; C01P 2004/52; C01P 2004/62; C01P 2004/64; C01P 2006/12

(57) ABSTRACT

A composition comprising monodispersed spherical rare earth oxide particles having an average particle size of about 20 nm to about 300 nm. The rare earth oxide particles of this composition have a calculated particle size diameter D in nm: Formula (I) where SSA is BET surface area in m²/g and p is density in g/cm³, that is less than about 25% different than the observed particle size diameter measured by SEM. The rare earth particles can be D_{y2}O₃, H_{O2}O₃, Lₐ₂O₃, and Y₂O₃ particles. This composition has beneficial properties for ceramic and electronic uses. Processes for making these particles and uses of these particles are further included.

### CROSS-REFERENCE OF RELATED APPLICATIONS

This application is being filed on 25 Mar. 2024 (23 Mar. 2023 falling on a Saturday), as a PCT International application and claims priority to and the benefit of U.S. Provisional Patent Application No. 63/491,805 filed on 23 Mar. 2023, the disclosure of which is hereby incorporated by reference in its entirety.

### FIELD OF THE INVENTION

This application relates to compositions of monodispersed spherical rare earth oxides having an average particle size of about 20 nm to about 300 nm, processes of producing these compositions, and uses for same in multilayer ceramic capacitors. The rare earth oxides of the compositions can be dysprosium oxide, holmium oxide, yttrium oxide, lanthanum oxide, or mixtures thereof.

### INTRODUCTION

Dysprosium oxide (Dy₂O₃), holmium oxide (Ho₂O₃), lanthanum oxide (La₂O₃), and yttrium oxide (Y₂O₃) have uses in the glass industry and optical industry. These oxides have specialized uses in ceramics, glass, phosphors, lasers, and in multilayer ceramic capacitors. In particular, these oxides have uses as a photoluminescent and thermoluminescent material, in magnetic resonance imaging as a contrast agent, as well as an additive to the dielectric barium titanate component of multilayer ceramic capacitors to improve the electrostatic capacity.

In these uses, there is a need for small particle size rare earth oxide achieved without grinding. Increasing efforts have been devoted to the preparation of nano-oxide materials, whose size, shape, crystal structure and surface chemistry meet the requirements of such technological applications.

A challenging issue is achieving an acceptable yield when synthesizing these oxides in combination with precise control over the morphology (size, shape, surface chemistry, particle size dispersion, etc.). As such, increasing efforts have been devoted to the preparation of these oxides, whose size, shape, crystal structure, and surface chemistry meet the requirements of the end use technological applications.

Therefore, developing a simple and efficient method to prepare compositions of these rare earth oxides having particular morphology and particle sizes at high yields remains a need.

### SUMMARY

Disclosed herein are compositions comprising monodispersed spherical rare earth oxide particles. These compositions have an average particle size of about 20 nm to about 300 nm, wherein the rare earth oxide particles have a calculated particle size diameter D in nm:

$$D = \frac{6000}{S S A \times ρ}$$

where SSA is BET surface area in m²/g and ρ is density in g/cm³, that is less than about 25% different than the observed particle size diameter measured by SEM. In certain embodiments the rare earth oxide particles are Dy₂O₃, Ho₂O₃, Y₂O₃, La₂O₃ or mixtures thereof.

Also disclosed herein is a process of producing monodispersed spherical rare earth particles. The process comprises: (a) mixing a rare earth salt, polymeric additive, and a precipitant in a solvent to provide a rare earth precursor mixture; (b) hydrothermally reacting the rare earth precursor mixture to form a precipitate; and (c) calcining the precipitate to provide monodispersed spherical rare earth particles. The process provides monodispersed spherical rare earth oxide particles having an average particle size of about 20 nm to about 300 nm, with the rare earth oxide particles having a calculated particle size diameter D in nm:

$$D = \frac{6000}{S S A \times ρ}$$

where SSA is BET surface area in m²/g and ρ is density in g/cm³, that is less than about 25%, or even less than 20%, different than the observed particle size diameter measured by SEM.

### BRIEF DESCRIPTION OF THE DRAWINGS

FIG. 1 illustrates a flowchart of an embodiment of the process of making monodispersed spherical rare earth oxides as described herein.

FIG. 2A is a SEM of the Dy₂O₃ particles of Example 1.

FIG. 2B is a graph illustrating the particle size distribution (PSD) profile of the Dy₂O₃ particles of Example 1. It shows a single peaked particle size profile.

FIG. 2C is an x-ray powder diffractogram (XRPD) of the Dy₂O₃ of Example 1, after calcining, and shows characteristics of cubic phase.

FIG. 3A is a SEM of the Dy₂O₃ of Example 2.

FIG. 3B is a graph illustrating the PSD profile of the Dy₂O₃ of Example 2. It shows a single peaked particle size profile.

FIG. 3C is an XRPD of the Dy₂O₃ of Example 2, after calcining, and shows characteristics of cubic phase.

FIG. 4A is a SEM of the Ho₂O₃ of Example 3.

FIG. 4B is a graph illustrating the PSD profile of the Ho₂O₃ of Example 3. It shows a single peaked particle size profile.

FIG. 4C is an XRPD of the Ho₂O₃ of Example 3, after calcining, and shows characteristics of cubic phase.

FIG. 5A is a SEM of the Dy₂O₃ for Example 4.

FIG. 5B is an XRPD of the Dy₂O₃ of Example 4, after calcining, and shows characteristics of cubic phase.

FIG. 6A is a SEM of the Dy₂O₃ for Example 5.

FIG. 6B is an XRPD of the Dy₂O₃ of Example 5, after calcining, and shows characteristics of cubic phase.

FIG. 7A is a SEM image for the Ho₂O₃ for Comparative Example 1.

FIG. 7B is a graph illustrating the PSD profile of the Ho₂O₃ of Comparative Example 1.

FIG. 7C is an XRPD of the Dy₂O₃ of Comparative Example 1, after calcining, and shows characteristics of cubic phase.

FIG. 8A is a SEM of the Dy₂O₃ of Comparative Example 2.

FIG. 8B an XRPD of the Dy₂O₃ of Comparative Example 2, after calcining, and shows characteristics of cubic phase.

FIG. 9A is a SEM image for the Dy₂O₃ of Comparative Example 3.

FIG. 9B is an XRPD of the Dy₂O₃ of Comparative Example 3, after calcining, and shows characteristics of cubic phase.

### DETAILED DESCRIPTION

Disclosed herein are compositions comprising monodispersed spherical rare earth oxide particles having an average particle size of about 20 nm to about 300 nm. The rare earth oxide particles have a calculated particle size diameter D in nm:

$$D = \frac{6000}{S S A \times ρ}$$

where SSA is BET surface area in m²/g and ρ is density in g/cm³, that is less than about 25% different than the observed particle size diameter measured by SEM. The rare earth oxide particles can be Dy₂O₃, Ho₂O₃, Y₂O₃, La₂O₃ or mixtures thereof.

Before the compositions containing monodispersed spherical rare earth oxides and processes for making these compositions are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present application relates to monodispersed spherical rare earth oxide particles. These rare earth oxide particles can be Dy₂O₃, Ho₂O₃, Y₂O₃, La₂O₃ or mixtures thereof. As disclosed herein, these novel rare earth particles exhibit a number of physical characteristics that distinguish them and provide improved physical characteristics and advantageous properties for end uses. These end uses include multilayer ceramic capacitors.

The particles as disclosed herein are rare earth oxides. Rare earths oxides include oxides of any of the rare earth elements. The rare earths can be selected from the group consisting of cerium (Ce), yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), and mixtures thereof. In particular embodiments, the rare earth oxides are Dy₂O₃, Ho₂O₃, Y₂O₃, La₂O₃, or mixtures thereof.

The particles importantly also have an average particle size of about 20 nm to about 300 nm. In certain embodiments, the particles have an average particle size of about 20 nm to about 100 nm or about 20 nm to about 50 nm.

Particle size analysis was done using a Microtrac S3500 particle size analyzer. A typical measurement is done by using approximately 0.1 grams of a powder sample, 10 ml of a 2% sodium hexametaphosphate solution is added to the sample. The sample+solution are then sonicated for approximately 3 minutes. A few drops of the sonicated solution are then added to the sample container of the instrument. The sample is again sonicated in the machine for another 3 minutes. Three consecutive runs are done by the machine according to the instrument manufacturer instruction manual. The three runs are averaged and the results recorded.

Laser diffraction (LD) is used for measuring particle size distribution (PSD). Dynamic light scattering (DLS) technique is another technique that can be used to measure PSD. While both LD and DLS can be used to measure PSD, the model used is different. For DLS, the velocity of particle movement is a function of the particle size. For LD, the diffracted/scattered intensity vs. angle (diffraction pattern) is a function of the particle size. Although they are based on different models, the dispersity theory should be the same since it is only a mathematic calculation based on the PSD.

The rare earth oxide particles as disclosed herein are monodispersed spherical particles. Dispersity is a measure of the heterogeneity (or uniformity) of particle sizes in a mixture. It can be indicated by the polydispersity index (PDI) parameter as derived from the DLS technique or the LD technique. Specifically, from the particle size distribution (PSD) profile, the mean and standard deviation (stddev) are obtained and expressed in the form of (stddev/mean)² to yield the PDI value. Information on this analysis technique also can be found at https://www.materials-talks.com/blog/2017/10/23/polydispersity-what-does-it-mean-for-dls-and-chromatography/, which is herein incorporated by reference as needed.

TABLE A
Approximate values for dispersity parameters

| | | Distribution Type | | | |
|---|---|---|---|---|---|
| | | monodisperse | | polydisperse | |
| | Definition | uniform | narrow | moderate | broad |
| PDI from | =(stddev/mean)² | 0.0 | 0.0-0.1 | 0.1-0.4 | >0.4 |
| PSD | | | | | |

As illustrated in Table A, the PDI value for a perfectly uniform sample is 0.0. The compositions as described herein are “monodispersed”, which means that the PDI value of the rare earth particles is in the range of about 0.0 to 0.1.

The present monodispersed spherical rare earth oxide particles have a calculated particle size diameter D in nm:

$$D = \frac{6000}{S S A \times ρ}$$

where SSA is BET surface area in m²/g and ρ is density in g/cm³. Since the rare earth oxide particles are monodispersed and spherical, D as calculated is less than about 25% different than the observed particle size diameter measured by SEM.

As such, as disclosed herein, “monodispersed spherical” means that the rare earth oxide particles have a calculated particle size diameter D in nm:

$$D = \frac{6000}{S S A \times ρ}$$

where SSA is BET surface area in m²/g and ρ is density in g/cm³ that is less than about 25% different than the observed particle size diameter measured by SEM.

To derive this equation, the area of a sphere is πD², and its volume will be πD³/6. Thus, the surface area of a highly dispersed nano-spherical material with a narrow size distribution will be πD²÷(πD³/6×ρ).

In some embodiments of the monodispersed spherical rare earth oxide particles, the calculated particle diameter (D) may be less than about 20% different than the observed particle size diameter measured by SEM. In particular embodiments of the monodispersed spherical rare earth oxide particles, the calculated particle diameter (D) may be less than about 15% different than the observed particle size diameter measured by SEM.

In certain embodiments, the rare earth oxide particles are Dy₂O₃ and ρ is 7.8 g/cm³. In other embodiments, the rare earth oxide particles are Ho₂O₃ and ρ is 8.4 g/cm³. In other embodiments, the rare earth particles are Y₂O₃ and ρ is 5.0 g/cm³. In further embodiments, the rare earth particles are La₂O₃ and ρ is 6.5 g/cm³.

As described above, the rare earth oxide particles have an average particle size of about 20 nm to about 300 nm. In some embodiments, the rare earth oxide particles can have a single peaked particle size profile. In some of these embodiments, the particles can have a D₅₀ of about 50 nm to about 500 nm. In some embodiments, the particles can have a D₉₉ of about 300 nm to about 1 μn. In some embodiments, the particles can have a D₁₀ of about 20 nm to about 100 nm.

In particular embodiments, the rare earth oxide particles can have a D₅₀ of about 50 nm to about 250 nm. In particular embodiments, the rare earth oxide particles can have a D₉₉ of about 300 nm to about 850 nm. In certain embodiments, the rare earth oxide particles have a D₁₀ of about 20 nm to about 100 nm.

In certain of these embodiments, the rare earth oxide particles can have a D₅₀ of about 120 nm to about 160 nm. In certain of these embodiments, the rare earth oxide particles can have a D₉₉ of about 375 nm to about 750 nm. In certain of these embodiments, the rare earth oxide particles can have a D₁₀ of about 40 to about 90 nm.

In embodiments, any of the listed D₁₀, D₅₀, and D₉₀ ranges may be combined with one another.

In some embodiments, the rare earth oxide particles as disclosed herein also have a BET surface area of about 1 to about 70 m²/g. The apparent surface area of the compositions was determined by using a Micromeritics Tristar II system and nitrogen at about 77 Kelvin. In compliance with commonly accepted procedures, the determination of surface area as used herein, the application of the BET equation was limited to the pressure range where the term na(1−P/Po) of the equation continuously increases with P/Po. The out gassing of the sample was done under nitrogen at about 350 degrees Celsius for about 2 hours.

In some embodiments, the rare earth oxide particles as disclosed herein have a loss on ignition (LOI) at the calcination temperature of less than about 5%. In certain embodiments, the LOI is less than about 2.5%. As described herein, LOI was measured by determining the sample mass before and after calcination of the products at 1000° C. for 1 h.

Importantly, the rare earth oxide particles disclosed herein have a spherical shape, and do not agglomerate in any significant way. In certain embodiments, the X-ray diffraction pattern of the rare earth oxide particles illustrates a single cubic phase with a crystalline structure, which can serve as a fingerprint for the periodic atomic arrangements in the material.

Without being bound by the theory, it is believed that the rare earth oxide particles as disclosed herein having the particularly recited spherical shape and size provide many beneficial technical effects, particularly for use in multilayer ceramic capacitors. The unique shape in combination with the size provide for better mixing and no significant agglomeration. This leads to improved efficiencies in end uses, such as multilayer ceramic capacitors. The particularly recited shape and size may provide for improved electric performances of dielectrics and reliability. Electric properties and related reliability may be attributed to solubility and distribution of rare earth oxides. The particularly recited shape and size may improve the solubility and distribution of the rare earth oxide particles as described herein.

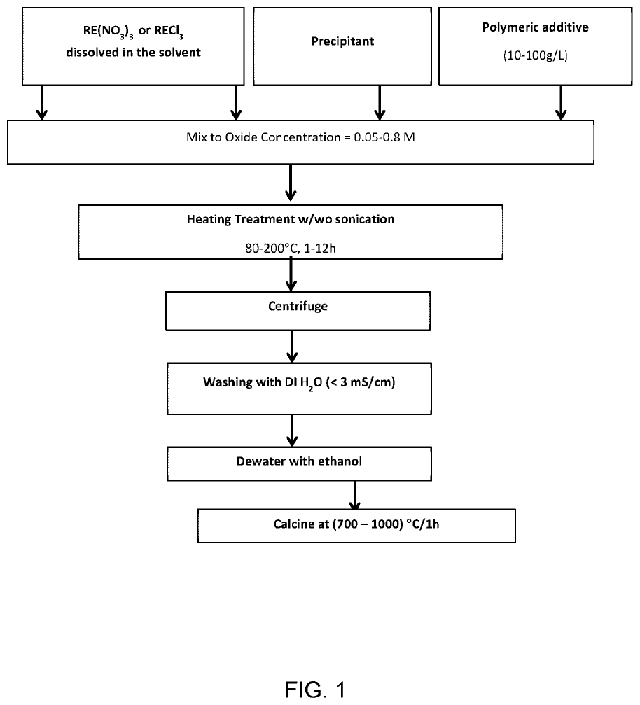

The rare earth oxide particles as disclosed herein are made by a particular process that provides the particles with the calculated particle size diameter D in nm:

$$D = \frac{6000}{S S A \times ρ}$$

where SSA is BET surface area in m²/g and ρ is density in g/cm³ that is less than about 25% different than the observed particle size diameter measured by SEM. FIG. 1 is a flow chart for an embodiment of a process of producing monodispersed spherical rare earth oxide particles. This process includes steps of (a) mixing a rare earth salt, polymeric additive, and a precipitant in a solvent to provide a rare earth precursor mixture; (b) hydrothermally reacting the rare earth precursor mixture to form a precipitate; and (c) calcining the precipitate to provide monodispersed spherical rare earth oxide particles.

The processes disclosed herein do not require a grinding or milling step, though grinding may be used in the disclosed process. However, if grinding is used, it does not change or provide the disclosed monodispersed spherical morphology. As such, the monodispersed spherical rare earth oxide particles may be obtained without any grinding. The process as described provides the rare earth oxide particles with the properties and characteristics as described above.

A rare earth salt, polymeric additive, and a precipitant are mixed in a solvent to provide a rare earth precursor solution. The rare earth salt is water soluble and, in the process, the rare earth salt is dissolved in water. The salts can be salts of inorganic or organic acids, for example chloride, sulfate, nitrate, acetate, and the like that are water soluble. In certain embodiments, the rare earth salt can be either a chloride or nitrate salt. As described herein, the rare earth of the salt may be Dy, Ho, Y or La.

The polymeric additive may be polyvinylpyrrolidone (PVP), polyvinyl alcohol (PVA), polyethyleneimine (PEI), Polyethylene glycol (PEG), or mixtures thereof. The polymeric additive can be any polymer that assists in processability of the rare earth precursor mixture and is removed during washing and calcination. Herein, the role of the polymeric additive is to affect the particle size and morphology by providing selective surface stabilization and/or access to kinetically controlled growth conditions. The polymeric additive may be added in an amount of about 5 to about 100 g/L.

The precipitant used may be urea, biuret, ammonia solution, ammonia bicarbonate, ammonia oxalate, or mixtures thereof. The precipitant may be mixed in an amount of about 1 to about 100 moles of precipitant per mole of rare earth.

In embodiments, the solvent may be deionized water (DI), ethanol, methanol, acetone, or mixtures thereof.

In certain embodiments, the rare earth precursor mixture may have a rare earth concentration of about 0.05 mol/L to about 0.8 mol/L, or a rare earth concentration of about 10 to about 160 g/L.

In certain embodiments, prior to step (b), the rare earth precursor mixture of step (a) can be homogenized by stirring or sonication before the solution is hydrothermally reacted in step (b). In other embodiments, the homogenizing may be omitted. After homogenizing the rare earth precursor mixture can be filtered and poured into a hydrothermal reactor for step (b).

The rare earth precursor mixture is hydrothermally reacted to form a precipitate. The hydrothermal reaction may be conducted at a temperature of about 80° C. to about 220° C. and for about 1 to about 12 hours. The hydrothermally reacting provides a precipitate.

In certain embodiments, the precipitate may be collected by centrifugation. In certain embodiments, the precipitate may be washed with DI water to remove residual quantities of bound or adsorbed ions, such as nitrates and chlorides, and then dewatered with an appropriate solvent, such as ethanol, before calcining. In certain embodiments, the crystalline precipitate is particularly free of anionic impurities, as characterized by a conductivity of less than about 10 μS/cm after washing.

In certain embodiments, the washed and optionally dewatered precipitate may be dried at about 40° C. to about 80° C. and for about 4 to about 24 hours before calcining in step (c).

The precipitate is calcined to provide the monodispersed spherical rare earth oxide particles as described herein. The calcining can be conducted at a temperature of about 500° C. to about 1000° C. and for from about 30 mins to about 4 hours. The calcining should be sufficient to remove the polymeric additive. In certain embodiments the calcining can be conducted at a temperature of from about 575° C. to about 700° C. and for about 45 mins to about 1½ hours.

The process as described herein provides the monodispersed spherical rare earth oxide particles having any or all of the above described characteristics and properties.

The following Examples are given to illustrate the inventive method for the preparation of monodispersed nano spherical rare earth oxide particles and characterization thereof in more detail, although the scope of the invention is never limited thereby in any way.

In the following examples, a Hitachi SU5000 FE-SEM was used to take high-resolution SEM images to determine the average particle size by measuring 100 particles and morphology. A Microtrac S3500 was used to determine the D₁₀, D₅₀, D₉₉ and dispersity of the particles. Malvern Panalytical Empyrean X-ray diffractometers were used to determine the crystalline structures of the final products. A Micromeritics Tristar II was used to determine the specific surface area (SSA) of the final products. Finally, a muffle furnace was used to determine the LOI by calcining the sample at about 1000° C. for about 1 hour.

FIG. 1 is a flow chart for an embodiment of a process of producing monodispersed spherical rare earth oxide particles, as illustrated in the Examples that follow.

### Comparative Example 1: Ho₂O₃ without PVP

The following was done:
1) 5 g of urea were weighed and dissolved in a mixture of 75 ml ethanol and 100 ml DI water.
2) The Ho precursors were prepared by dissolving 10 g Ho(NO₃)₃·xH₂O (TREO˜42%) in 175 ml DI water.
3) The above two solutions were mixed and sonicated at 80 k Hz for thirty min.
4) The solution was filtered and poured into a hydrothermal reactor.
5) The mixture was hydrothermally treated at 190° C. for two hours.
6) The precipitates were collected by centrifugation and washed with deionized water to achieve a conductivity of less than 10 μS/cm.
7) The solid was dewatered with ethanol for three washes to obtain a wetcake.
8) The wetcake was dried at 60° C. overnight.
9) The dried products were calcined at 700° C. for one hour.

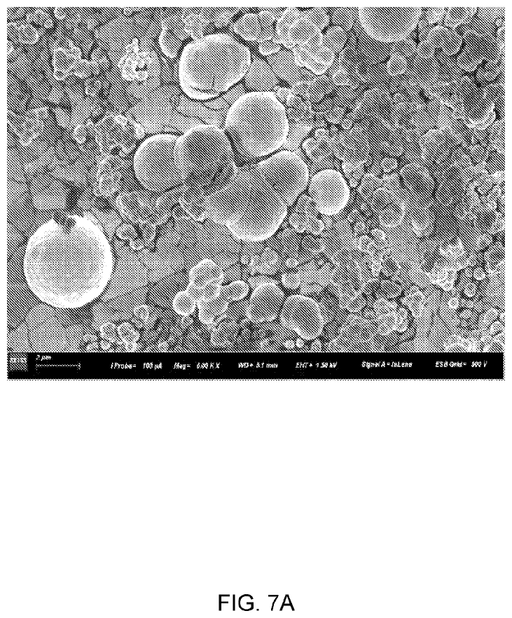

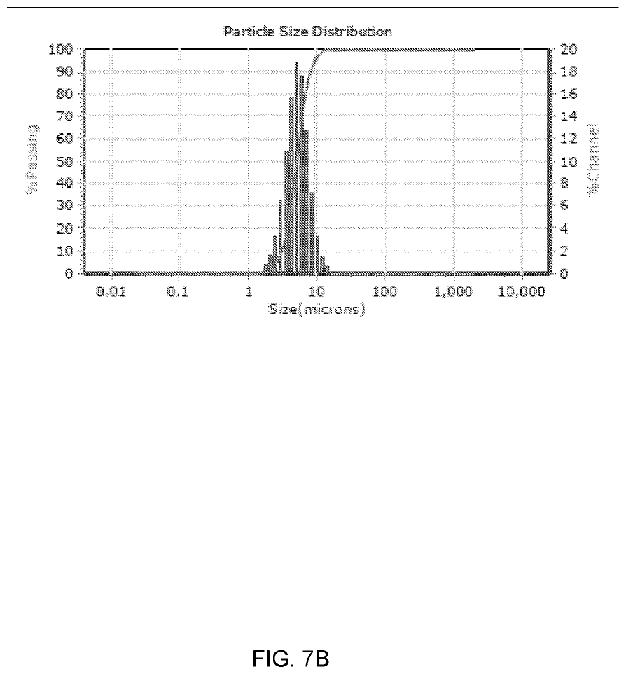

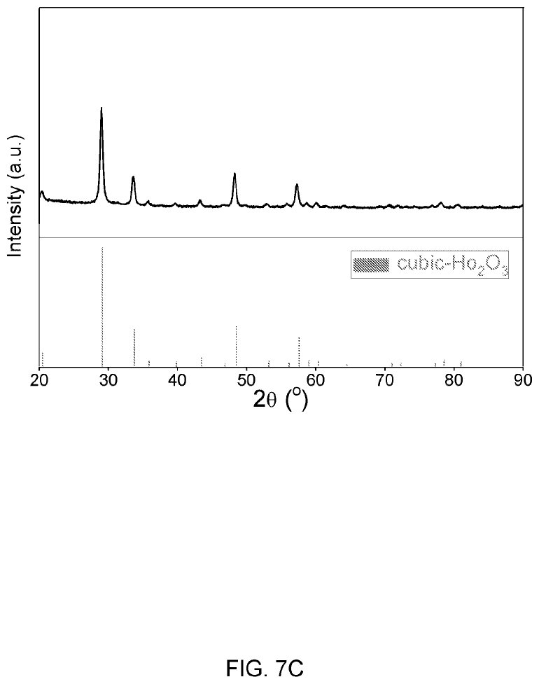

The Ho₂O₃ particles had a distorted spherical shape—not a monodispersed spherical shape as described and defined herein. The Ho₂O₃ particles were examined by scanning electron microscopy (SEM) and the holmium oxide comprised particles with a distorted spherical shape had an average particle size of ˜950 nm (i.e., ˜944.9 nm by SEM) (FIG. 7A). The particle size analysis of these Ho₂O₃ particles showed that the particles had a D50 of 5.15 μm and a wide single peaked particle size profile (FIG. 7B). The calcined product was analyzed by XRPD and showed the material to possess a cubic phase (FIG. 7C). The particles as analyzed also had a BET SSA of 8.99 m²/g, where the Size_{BET}=85 nm.

TABLE 1
Characteristics of Comparative Example 1

| Percentile | Size | |
|---|---|---|
| D99 | 12.3 | μm |
| D50 | 5.15 | μm |
| D10 | 3.13 | nm |
| SSA | 8.99 | m²/g |

| | |
|---|---|
| LOI | 2.04% |

### Comparative Example 2: Dy₂O₃ by Mechanical Mixing with Tartaric Acid (WO2005026045A2)

The following was done as disclosed in WO 2005/026045:
1) An amount of 4.6478 g Dy(NO₃)₃·xH₂O was weighed.
2) The above crystals were hand mixed with 5.1080 g tartaric acid in a mortar for thirty minutes.
3) The mixture was heated on a 250° C. hot plate.
4) The product was calcined at 800° C. for two hours.

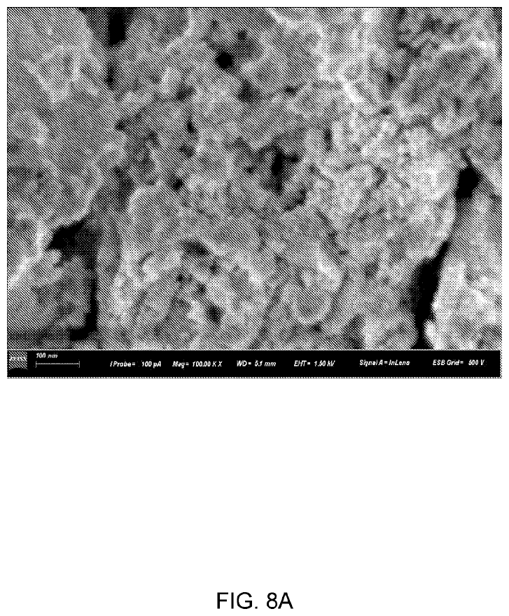

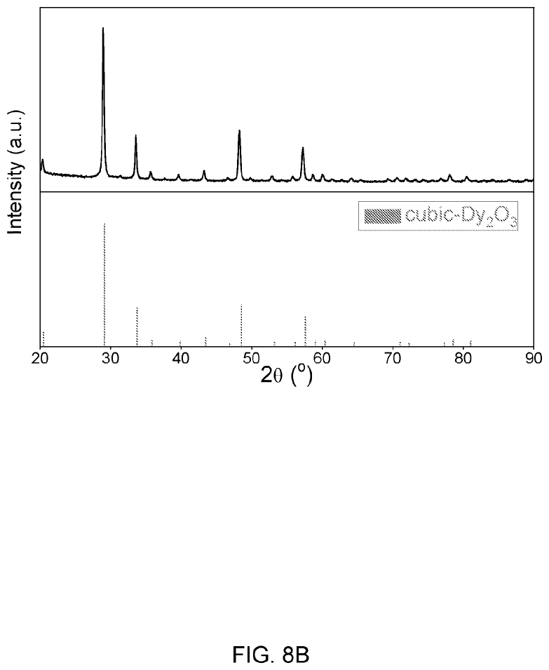

The Dy₂O₃ particles were examined by scanning electron microscopy (SEM) (FIG. 8A) and by XRPD (FIG. 8B).

### Comparative Example 3: Dy₂O₃ by Urea Precipitation (JP2005247673A)

The following was done as disclosed in JP 2005/247673:
1) 80 ml Dy(NO₃)₃ solution ([Dy³⁺]˜0.311M) was diluted to 200 ml with DI water.
2) 30.03 g of urea were weighed and dissolved in DI water to achieve a total volume of 300 ml.
3) The above two solutions were combined by stirring.
4) 2.7803 g trimethylamine N-oxide dihydrate was added into the above solution under stirring.
5) The mixed solution was heated to 90° C. for thirty minutes.
6) The product was collected via centrifuge and dried at 80° C. for two hours.
7) The dried product was calcined at 700° C. for one hour.

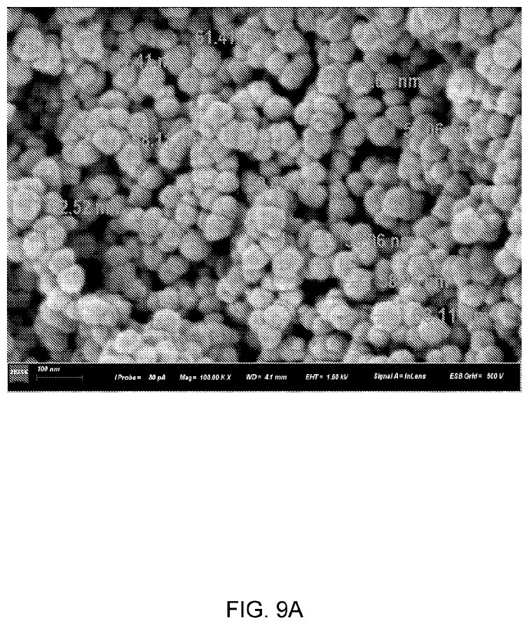

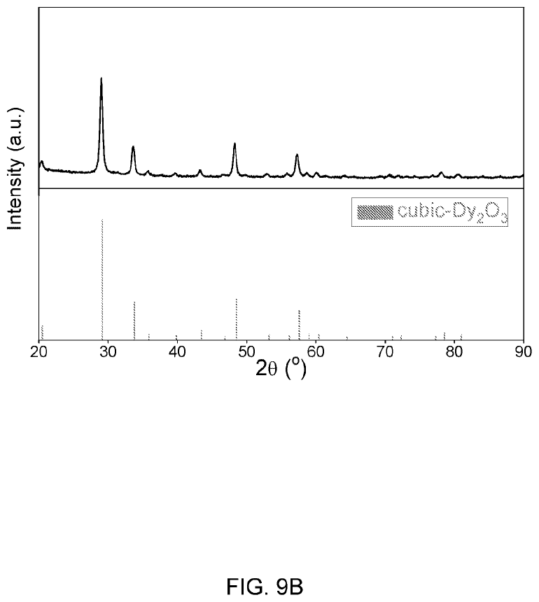

The Dy₂O₃ particles were examined by scanning electron microscopy (SEM) (FIG. 9A) and by XRPD (FIG. 9B).

### Example 1: Dy₂O₃ Particles

The following was done:
1) 5 g of urea were weighed and dissolved in 175 ml DI water.
2) The Dy precursors were prepared by dissolving 20 g PVP (Mw ˜1,300,000, Sigma) and 10 g Dy(NO₃)₃·xH₂O (TREO˜40%) in 175 ml DI water.
3) The above two solutions were mixed and sonicated at 80 k Hz for thirty minutes.
4) The solution was filtered and poured into a hydrothermal reactor.
5) The mixture was hydrothermally treated at 180° C. for one- and one-half hours.
6) The precipitates were collected by centrifugation and washed with deionized water to achieve a conductivity of less than 10 μS/cm.
7) The solid was dewatered with ethanol for three washes to obtain a wetcake.
8) The wetcake was dried at 60° C. overnight.
9) The dried products were calcined at 580° C. for one hour.

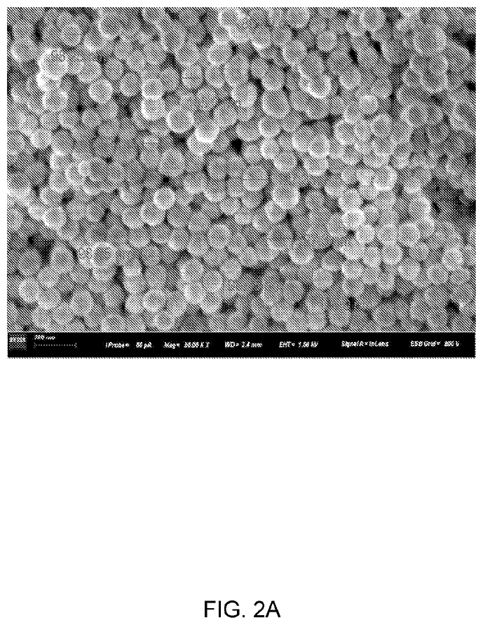

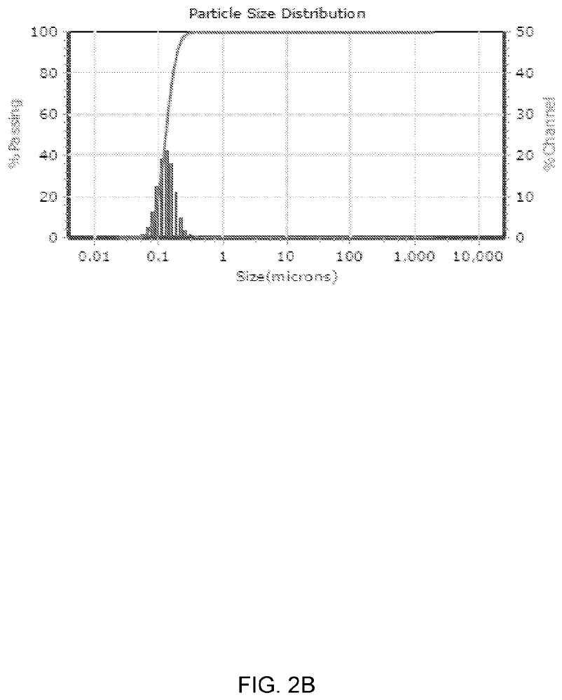

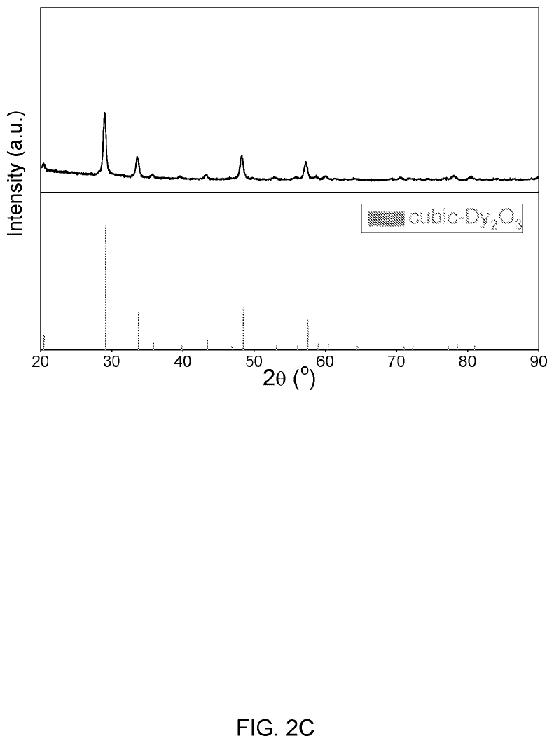

The Dy₂O₃ particles had a monodispersed spherical shape as defined herein. The Dy₂O₃ particles were examined by scanning electron microscopy (SEM) and the dysprosium oxide comprised particles with a spherical shape had an average particle size of ˜100 nm (i.e., ˜105.4 nm by SEM) (FIG. 2A). The particle size analysis of these Dy₂O₃ particles showed that the particles had a D₉₉ of 474 nm and a D₅₀ of 131 nm and a single peaked particle size profile (FIG. 2B). The calcined product was analyzed by XRPD and showed the material to possess a single cubic phase (FIG. 2C). The particles as analyzed also had a BET SSA of 8.29 m²/g, where the Size_{BET}=87 nm. The monodispersed PSD profile indicated that the particles were nanosized with a D₉₉ of 474 nm and D₅₀ of 131 nm.

TABLE 2
Characteristics of Example 1

| Percentile | Size | |
|---|---|---|
| D99 | 474 | nm |
| D50 | 131 | nm |
| D10 | 85 | nm |
| SSA | 8.29 | m²/g |

| | |
|---|---|
| LOI | 1.53% |

### Example 2: Dy₂O₃ Particles

Steps 1 to 6 of Example 1 were followed, but the dried products were calcined at 700° C. for one hour.

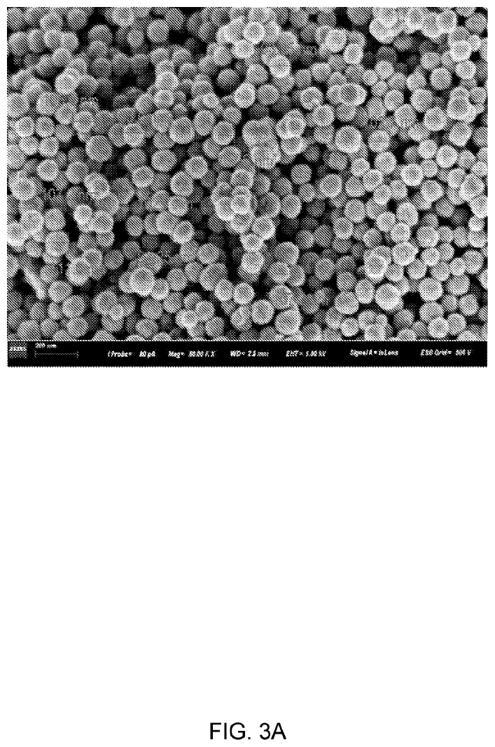

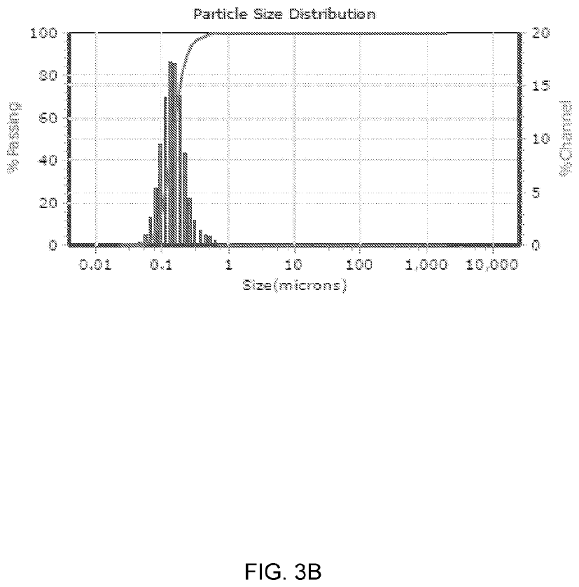

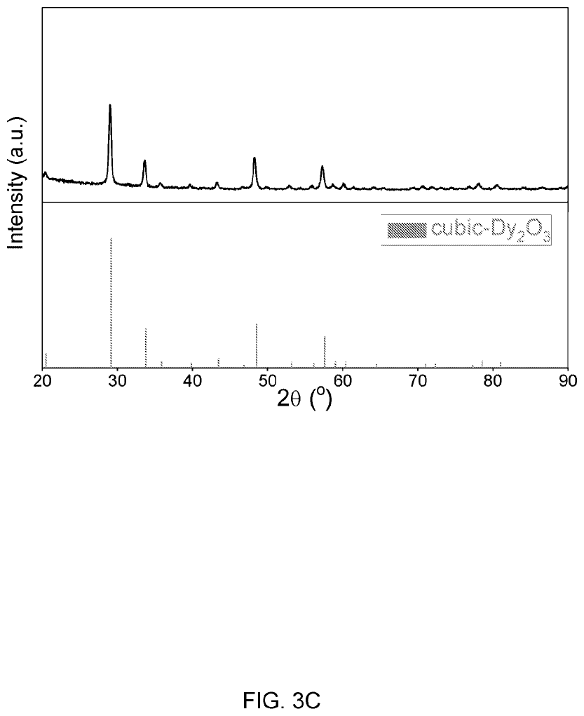

The Dy₂O₃ particles had a monodispersed spherical shape as defined herein. The Dy₂O₃ particles were examined by scanning electron microscopy (SEM) and the dysprosium oxide comprised particles with a monodispersed spherical shape had an average particle size of ˜100 nm (i.e., ˜103.5 by SEM) (FIG. 3A). The particle size analysis of these Dy₂O₃ particles showed that the particles had a D₉₉ of 684 nm and a D₅₀ of 145 nm and a single peaked particle size profile (FIG. 3B). The calcined product was analyzed by XRPD and showed the material to possess a single cubic phase (FIG. 3C). The particles as analyzed also had a BET SSA of 8.18 m²/g, where the Size_{BET}=88 nm. The monodispersed PSD profile indicated that the particles were nanosized with a D₉₉ of 684 nm and D₅₀ of 145 nm.

TABLE 3
Characteristics of Example 2

| Percentile | Size | |
|---|---|---|
| D99 | 684 | nm |
| D50 | 145 | nm |
| D10 | 88 | nm |
| SSA | 8.18 | m²/g |

| | |
|---|---|
| LOI | 0.97% |

### Example 3: Ho₂O₃ Particles

The following was done:
1) 5 g of urea were weighed and dissolved in a mixture of 75 ml Ethanol and 100 ml DI water.
2) The Ho precursors were prepared by dissolving 22 g PVP (Mw ˜1,300,000, Sigma) and 10 g Ho(NO₃)₃·xH₂O (TREO˜42%) in 175 ml DI water.
3) The above two solutions were mixed and sonicated at 80 k Hz for thirty min.
4) The solution was filtered and poured into a hydrothermal reactor.
5) The mixture was hydrothermally treated at 190° C. for two hours.
6) The precipitates were collected by centrifugation and washed with deionized water to achieve a conductivity of less than 10 μS/cm.
7) The solid was dewatered with ethanol for three washes to obtain a wetcake.
8) The wetcake was dried at 60° C. overnight.
9) The dried products were calcined at 700° C. for one hour.

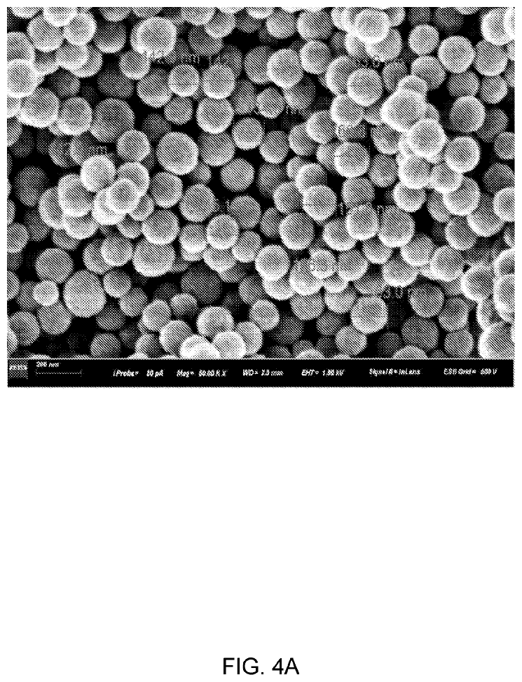

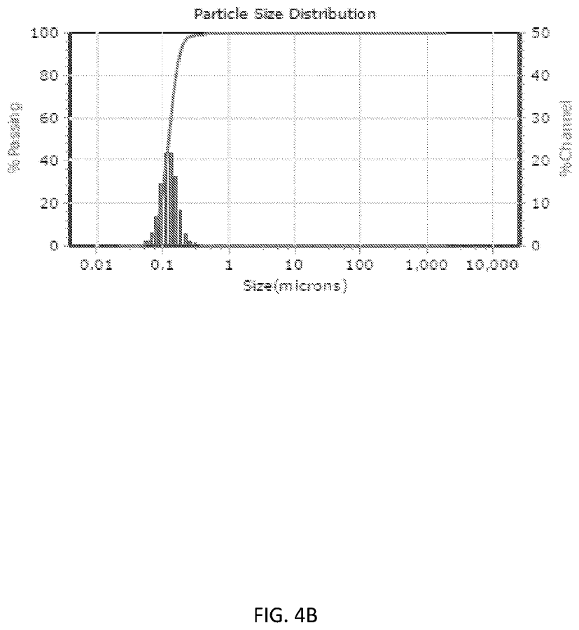

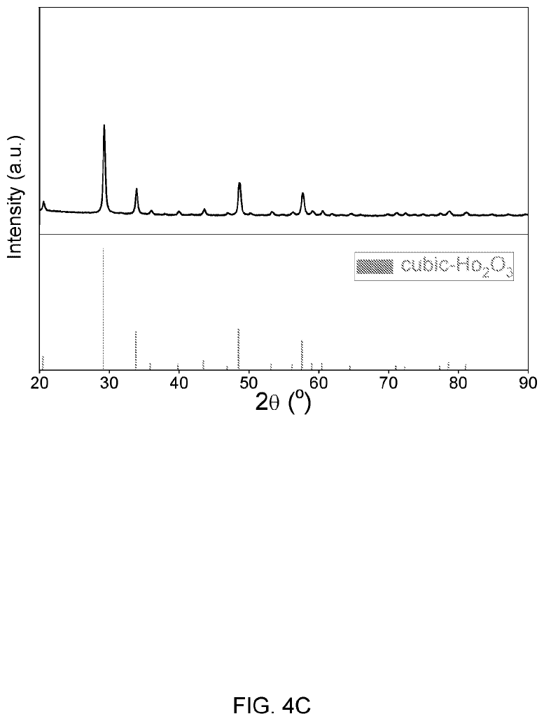

The Ho₂O₃ particles had a monodispersed spherical shape as defined herein. The Ho₂O₃ particles were examined by scanning electron microscopy (SEM) and the holmium oxide comprised particles with a monodispersed spherical shape had an average particle size of ˜150 nm (i.e., ˜158.3 by SEM) (FIG. 4A). The particle size analysis of these Ho₂O₃ particles showed that the particles had a D₉₉ of 409 nm and a D₅₀ of 124 nm and a single peaked particle size profile (FIG. 4B). The calcined product was analyzed by XRPD and showed the material to possess a single cubic phase (FIG. 4C). The particles as analyzed also had a BET SSA of 4.98 m²/g, where the Size_{BET}=143 nm. The monodispersed PSD profile indicated that the particles were nanosized with a D₉₉ of 409 nm and D₅₀ of 124 nm.

TABLE 4
Characteristics of Example 3

| Percentile | Size | |
|---|---|---|
| D99 | 409 | nm |
| D50 | 124 | nm |
| D10 | 83 | nm |
| SSA | 4.98 | m²/g |

| | |
|---|---|
| LOI | 0.67% |

### Example 4: Dy₂O₃ Particles

The following was done:
1) 5.4 g of urea and 11.3 g PVP were weighed and dissolved in a mixture of 37.5 ml ethanol and 69 ml Dy(NO₃)₃ ([Dy³⁺]˜0.22M).
2) 27.5 ml of 1 mol/L NH₃·H₂O and 16 ml of DI water were added into the above solution.
3) The solution was filtered and poured into a hydrothermal reactor.
4) The mixture was hydrothermally treated at 180° C. for two hours.
5) The precipitates were collected by centrifugation and washed with deionized water to achieve a conductivity of less than 10 μS/cm.
6) The solid was dewatered with ethanol for three washes to obtain a wetcake.
7) The wetcake was dried at 60° C. overnight.
8) The dried products were calcined at 700° C. for one hour.

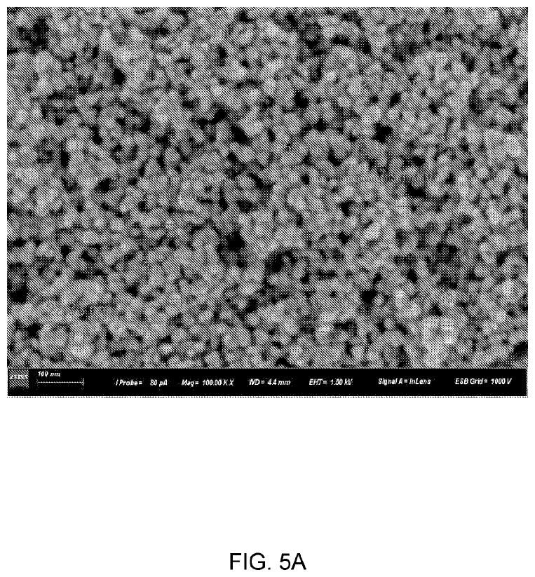

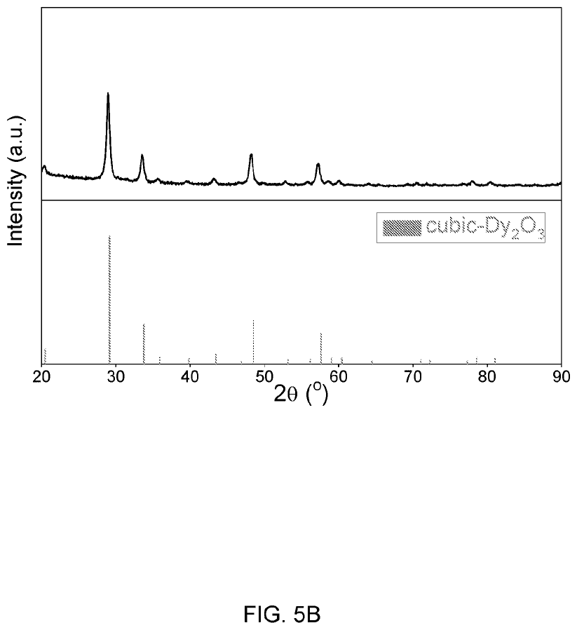

The Dy₂O₃ particles had a monodispersed spherical shape as defined herein. The Dy₂O₃ particles were examined by scanning electron microscopy (SEM) and the dysprosium oxide comprised particles with a monodispersed spherical shape had an average particle size of ˜30 nm (i.e., ˜28.3 by SEM) (FIG. 5A). The calcined product was analyzed by XRPD and showed the material to possess a single cubic phase (FIG. 5B). The particles as analyzed also had a BET SSA of 30.56 m²/g, where the Size_{BET}=24 nm.

TABLE 5
Characteristics of Example 4

| SSA | 30.56 m²/g |
|---|---|
| LOI | 2.07% |

### Example 5: Dy₂O₃ Particles

The following was done:
1) 6 g of urea and 12 g of PVP were weighed and dissolved in a mixture of 30 ml acetone and 60 ml Dy(NO₃)₃ ([Dy³⁺]˜0.22M).
2) 1 ml 1 mol/L NH₃·H₂O and 59 ml DI water are added into the above solution.
3) The solution was filtered and poured into a hydrothermal reactor.
4) The mixture was hydrothermally treated at 140° C. for four hours.
5) The precipitates were collected by centrifugation and washed with deionized water to achieve a conductivity of less than 10 μS/cm.
6) The solid was dewatered with ethanol for three washes to obtain a wetcake.
7) The wetcake was dried at 60° C. overnight.
8) The dried products were calcined at 700° C. for one hour.

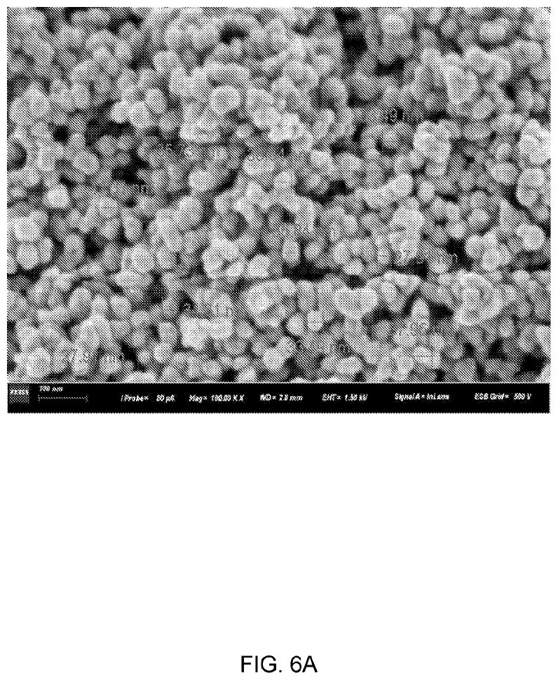

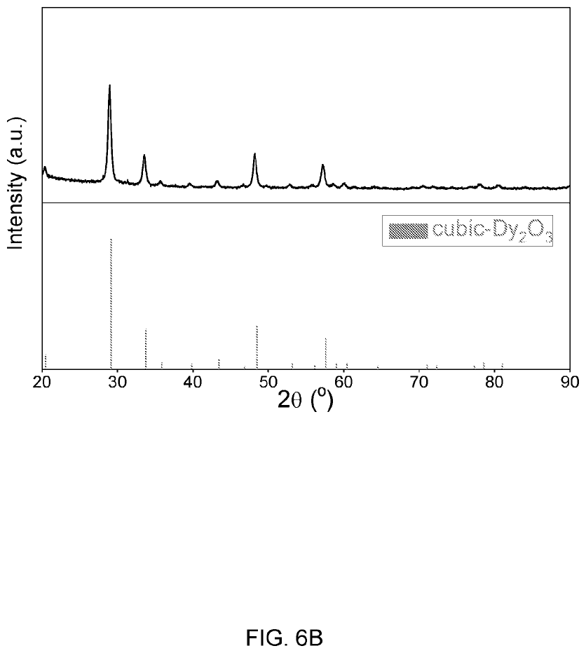

The Dy₂O₃ particles had a monodispersed spherical shape as defined herein. The Dy₂O₃ particles were examined by scanning electron microscopy (SEM) and the dysprosium oxide comprised particles with a monodispersed spherical shape had an average particle size of ˜40 nm (i.e., ˜36.0 nm by SEM) (FIG. 6A). The calcined product was analyzed by XRPD and showed the material to possess a single cubic phase (FIG. 6B). The particles as analyzed also had a BET SSA of 18.90 m²/g, where the Size_{BET}=38 nm.

TABLE 6
Characteristics of Example 5

| SSA | 18.90 m²/g |
|---|---|
| LOI | 2.03% |

### Summary of Calculated Particle Size Diameter vs Observed for Examples vs Comparative Examples

The following table summarizes the calculated particle size diameter vs the observed particle size diameter measured by SEM. As disclosed, the rare earth oxide particles as disclosed herein have a calculated particle size diameter D in nm:

$$D = \frac{6000}{S S A \times ρ}$$

where SSA is BET surface area in m²/g and ρ is density in g/cm³, that is less than about 20% different than the observed particle size diameter measured by SEM.

The results confirm that the comparative examples made by prior art methods are significantly greater.

TABLE 7
Comparison of the size by Calculated
Particle Size Diameter vs Observed

| Ex. No | Size by SEM (nm) | Size by SSA (nm) | Difference (%) |
|---|---|---|---|
| 1 | ~105.4 | 87 | 17.5 |
| 2 | ~103.5 | 88 | 15.0 |
| 3 | ~158.3 | 143 | 9.7 |
| 4 | ~28.3 | 24 | 15.2 |
| 5 | ~36.0 | 38 | 5.5 |
| CP 1 | ~944.9 | 85 | 91.0 |
| CP 2 | ~20.3 | 141 | 594.6 |
| CP 3 | ~58.4 | 41 | 29.8 |

CP: Comparative

As shown, the rare earth oxide particles as disclosed herein have a calculated particle size diameter D in nm:

$$D = \frac{6000}{S S A \times ρ}$$

where SSA is BET surface area in m²/g and ρ is density in g/cm³, that is less than about 20% different than the observed particle size diameter measured by SEM. In contrast, the rare earth oxide particles of the prior art (comparative examples) exhibit a calculated particle size diameter D that is measurably greater than the observed particle size diameter indicating that these particles have a distorted spherical shape—measurably and observably different than the particles as disclosed herein.

The rare earth oxide particles as disclosed herein having the particularly recited spherical shape and size provide many beneficial technical effects, particularly for use in multilayer ceramic capacitors. The unique shape in combination with the size provide for better mixing and no significant agglomeration. This leads to improved efficiencies in end uses, such as multilayer ceramic capacitors.

As devices such as multilayer capacitors are desired to be smaller and lighter, the components must assist in achieving this end result. The particularly recited shape and size may provide for improved electric performances of dielectrics and reliability. Electric properties and related reliability may be attributed to solubility and distribution of rare earth oxides. The particularly recited shape and size may improve the solubility and distribution of the rare earth oxide particles as described herein.

The spherical morphologies as defined herein and the particularly recited size may be beneficial for their use as powders, dispersion in liquid mediums, and for better mixing with and occupation of sites BaTiO₃ ceramics. The particles as disclosed herein may provide for improved electric performance and high reliability. The electric properties and related reliability of these capacitors can be attributed to solubility, distribution of the rare earth oxides, and their occupation site in BaTiO₃. The rare earth oxide particles as disclosed with the particularly recited spherical morphology and size may improve these properties.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A composition comprising monodispersed spherical rare earth oxide particles having an average particle size of about 20 nm to about 300 nm, wherein the rare earth oxide particles have a calculated particle size diameter D in nm:
$$D = \frac{6000}{S S A \times ρ}$$
where SSA is BET surface area in m²/g and ρ is density in g/cm³, that is less than about 25% different than the observed particle size diameter measured by SEM.

2. The composition of claim 1, wherein the particles have a single peaked particle size profile with a D₅₀ of about 50 nm to about 500 nm and a D₉₉ of about 300 nm to about 1 μn.

3. The composition of claim 2, wherein the rare earth oxide particles comprise Dy₂O₃, Ho₂O₃, Y₂O₃, La₂O₃ or mixtures thereof.

4. The composition of claim 3, wherein the rare earth oxide particles are Dy₂O₃ and ρ is 7.8 g/cm³.

5. The composition of claim 3, wherein the rare earth particles are Ho₂O₃ and ρ is 8.4 g/cm³.

6. The composition of claim 3, wherein the rare earth particles are Y₂O₃ and ρ is 5.0 g/cm³.

7. The composition of claim 3, wherein the rare earth particles are La₂O₃ and ρ is 6.5 g/cm³.

8. The composition of claim 2, wherein calculated particle size diameter (D) is less than about 20% different than the observed particle size diameter measured by SEM.

9. The composition of claim 2, wherein the particles have a D₅₀ of about 50 nm to about 250 nm and a D₉₉ of about 300 nm to about 850 nm.

10. The composition of claim 9, wherein the particles have a D₁₀ of about 20 nm to about 100 nm.

11. The composition of claim 2, wherein the particles have a BET surface area of about 1 to about 70 m²/g.

12. The composition of claim 2, wherein the particles have a single phase cubic crystalline structure.

13. The composition of claim 2, wherein the composition has a Loss on Ignition (LOI) of less than about 5%.

14. A process of producing monodispersed spherical rare earth oxide particles, the process comprising:
(a) mixing a rare earth salt, polymeric additive, and a precipitant in a solvent to provide a rare earth precursor mixture;
(b) hydrothermally reacting the rare earth precursor mixture to form a precipitate; and
(c) calcining the precipitate to provide monodispersed spherical rare earth oxide particles.

15. The process of claim 14, wherein the monodispersed spherical rare earth oxide particles have an average particle size of about 20 nm to about 300 nm and the rare earth oxide particles have a calculated particle size diameter D in nm:
$$D = \frac{6000}{S S A \times ρ}$$
where SSA is BET surface area in m²/g and ρ is density in g/cm³, that is less than about 20% different than the observed particle size diameter measured by SEM.

16. The process of claim 15, wherein the precipitant is selected from the group consisting of urea, biuret, ammonia solution, ammonia bicarbonate, ammonia oxalate, and mixtures thereof.

17. The process of claim 15, wherein the solvent is selected from the group consisting of deionized water, ethanol, methanol, acetone, and mixtures thereof.

18. The process of claim 15, wherein the polymeric additive is selected from the group consisting of polyvinylpyrrolidone (PVP), polyvinyl alcohol (PVA), polyethyleneimine (PEI), Polyethylene glycol (PEG), and mixtures thereof.

19. The process of claim 15, wherein the rare earth salt is a water-soluble salt, for example a chloride or nitrate salt, and the rare earth is Dy, Ho, Y or La.

20. The process of claim 15, wherein the rare earth precursor mixture of step (a) has a rare earth concentration of about 0.05 mol/L to about 0.8 mol/L or a rare earth concentration of about 10 to about 160 g/L.

21. The process of claim 15, wherein about 1 to about 100 moles of precipitant are mixed per mole of rare earth in step (a).

22. The process of claim 15, wherein the polymeric additive of step (a) is in an amount of about 5 to about 100 g/L.

23. The process of claim 15, wherein the calcining of step (c) is conducted at a temperature of about 500° C. to about 1000° C. and for about 30 mins to about 4 hours.

24. The process of claim 23, wherein the LOI from the calcining is less than 5%.

25. The process of claim 15, wherein the hydrothermally reacting of step (b) is conducted at a temperature of about 80° C. to about 220° C. and for about 1 to about 12 hours.

26. The process of claim 15, further comprising washing the precipitate of step (b) with water and dewatering the washed precipitate before calcining in step (c).

27. The process of claim 15, wherein the rare earth precursor mixture of step (a) is homogenized by stirring or sonication before the hydrothermally reacting in step (b).

28. The process of claim 26, further comprising drying the washed precipitant at about 40° C. to about 80° C. and for about 4 to about 24 hours before calcining in step (c).

29. (canceled)
